(19) United States
(12) Patent Application Publication
(10) Pub. No.: US 2025/0199250 A1
(43) Pub. Date: Jun. 19, 2025

(54) CONFIGURABLE OPTICAL FIBER CONNECTOR

(71) Applicant: Senko Advanced Components, Inc., Hudson, MA (US)

(72) Inventors: Kazuyoshi TAKANO, Tokyo (JP); Yim WONG, Basingstoke (GB); Jimmy CHANG, Sturbridge, MA (US)

(21) Appl. No.: 18/987,685

(22) Filed: Dec. 19, 2024

Related U.S. Application Data
(60) Provisional application No. 63/611,773, filed on Dec. 19, 2023.

(51) Int. Cl. G02B 6/38

(52) U.S. Cl. CPC G02B 6/3893; G02B 6/3825; G02B 6/3879

(57) ABSTRACT

A configurable fiber optic connector that can be used as a simplex connector or a duplex connector. The fiber optic connector includes a first housing member, and a second housing member. A first plug frame including a body and a ferrule received in the body is constructed to be held by the first housing member separate from the second housing member. A second plug frame including a body and a ferrule received in the body is constructed to be held by the second housing member separate from the first housing member. The first and second housing members can be connected to each other for holding the first and second plug frames together as a duplex fiber optic connector.

### CROSS-REFERENCE TO RELATED APPLICATIONS

This application claims priority to U.S. Provisional Patent Application No. 63/611,773, filed Dec. 19, 2023, which is hereby incorporated by reference in its entirety.

### FIELD

This disclosure generally pertains to a configurable optical fiber connector.

### BACKGROUND

The prevalence of the Internet has led to unprecedented growth in communication networks. Consumer demand for service and increased competition has caused network providers to continuously find ways to improve quality of service while reducing cost.

Certain solutions have included deployment of high-density interconnect panels. High-density interconnect panels may be designed to consolidate the increasing volume of interconnections necessary to support the fast-growing networks into a compacted form factor, thereby increasing quality of service and decreasing costs such as floor space and support overhead. However, room for improvement in the area of data centers, specifically as it relates to fiber optic connections, still exists. For example, manufacturers of connectors and fiber optic equipment suppliers are always looking to reduce the required inventories of connectors needed to supply different jobs requiring different connectors.

As shown in FIGS. 1, 2 and 26, an SN-type, duplex fiber optic connector 1 known in the art includes a unitary outer housing 3 and a unitary plug frame 5 holding two ferrules 7. As received in the outer housing 3, the ferrules 7 protrude forward of the front end of the outer housing. A dust cover 9 is provided to cover the exposed ends of the protruding ferrules 7 prior to making an optical connection with the connector 1. The plug frame 5 includes a post 11 to which a jacket of a cable 13 carrying two optical fibers is secured. The two optical fibers are terminated in respective ones of the ferrules 7. A boot 15 is constructed to attach to the outer housing 3 and holds the plug frame 5 in the outer housing. A SN-type, simplex fiber optic connector (not shown) would have a similar construction, but include one or more components unique to the simplex connector.

### SUMMARY

In one aspect, a configurable fiber optic connector according to the principles of the present invention generally comprises a first housing member and a second housing member. A first plug frame including a body and a ferrule received in the body is constructed to be held by the first housing member separate from the second housing member. A second plug frame including a body and a ferrule received in the body is constructed to be held by the second housing member separate from the first housing member. The first and second housing members being adapted to be connected to each other for holding the first and second plug frames together as a duplex fiber optic connector.

Other aspects and features will be in part apparent and in part pointed out hereinafter.

### BRIEF DESCRIPTION OF THE DRAWINGS

FIG. 1 is a perspective of a prior art SN-type connector;

FIG. 2 is an exploded perspective of the SN-type connector of FIG. 1;

FIG. 3 is a perspective of a duplex fiber optic connector according to the principles of the present invention;

FIG. 4 is an exploded perspective of the fiber optic connector of FIG. 3;

FIG. 5 is a perspective of a first housing member of the fiber optic connector of FIG. 3;

FIG. 6 is another perspective of the first housing member from a different vantage;

FIG. 7 is an enlarged, rear end perspective of the first housing member;

FIG. 8 is another rear end perspective of the first housing member from a different vantage;

FIG. 9 is a longitudinal section of the first housing member;

FIG. 10 is an enlarged perspective of a first plug frame of the fiber optic connector of FIG. 3;

FIG. 11 is a rear end perspective of the first plug frame;

FIG. 12 is a rear end perspective of a body of the first plug frame;

FIG. 13 is a front side perspective of the body;

FIG. 14 is a perspective of an inner body assembled with a post of the first plug frame;

FIG. 15 is a perspective of the first housing member and first plug frame positioned for assembly;

FIG. 16 is a perspective of the assembled first housing member and first plug frame as a simplex fiber optic connector;

FIG. 17 is a perspective similar to FIG. 16, but with parts of the first housing member and first plug frame broken away to show internal construction;

FIG. 18 is longitudinal section of the simplex fiber optic connector taken near the viewing plane;

FIG. 19 is another perspective of the assembled first housing member and first plug frame with different parts broken away to show internal construction;

FIG. 20 is another longitudinal section of simplex fiber optic connector taken on a centerline of the simplex fiber optic connector;

FIG. 21 is a perspective of a clip member of a clip of the duplex fiber optic connector;

FIG. 22 is a perspective of the duplex fiber optic connector is an elevation of the duplex fiber optic connector at the beginning of application of the clip members to connect the first and second housing members;

FIG. 23 is the perspective of FIG. 22 with the clip members connected to form the clip around cables of the simplex fiber optic connector;

FIG. 24 is the perspective of FIG. 23 but with the clip attaching two simplex fiber optic connectors together to form the duplex fiber optic connector;

FIG. 25 is a top plan, view of the duplex fiber optic connector with parts broken away to illustrate the clip connection.

FIG. 26 is a front end view of a prior art duplex fiber optic connector;

FIG. 27 is a front end view of the fiber optic duplex connector of FIG. 24 for comparison with the prior art duplex fiber optic connector of FIG. 26;

FIG. 28 is a section showing an adapter receiving two simplex fiber optic connectors according to the present invention in optical connection;

FIG. 29 is a section showing the adapter receiving two duplex fiber optic connectors according to the present invention in optical connection;

FIG. 30 is a perspective of a duplex fiber optic connection of a second embodiment, formed by connected simplex fiber optic connectors;

FIG. 31 is the perspective of FIG. 30 with a clip exploded from the duplex fiber optic connector;

FIG. 32 is a perspective similar to that of FIG. 30, but with parts broken away to show connection of the clip;

FIG. 33 is an enlarged front elevation of the duplex fiber optic connector of FIG. 30;

FIG. 34 is an enlarged perspective of the clip of FIG. 31;

FIG. 35 is a side elevation of the clip;

FIG. 36 is a top plan view of the clip;

FIG. 37 is a rear end view of the clip;

FIG. 38 is a perspective of a simplex fiber optic connector of a third embodiment;

FIG. 39 is a longitudinal section of the simplex fiber optic connectors of FIG. 38;

FIG. 40 is an interior perspective of two of the simplex fiber optic connectors of the third embodiment clipped together in stacked relation to form a duplex fiber optic connector;

FIG. 41 is a top perspective of two of the simplex fiber optic connectors of FIG. 38 clipped together in side-by-side relation to form another duplex fiber optic connector;

FIG. 42 is bottom side perspective of the other duplex fiber optic connector of FIG. 41;

FIG. 43 is a perspective of a transceiver and four duplex fiber optic connectors according to FIG. 24 positioned for plugging into the transceiver;

FIG. 44 is the perspective of FIG. 40 but with the duplex fiber optic connectors plugged into the transceiver;

FIG. 45 is a top plan view of the duplex fiber optic connectors and transceiver of FIG. 44; and

FIG. 46 is a side elevation of the duplex fiber optic connector and transceiver of FIG. 44.

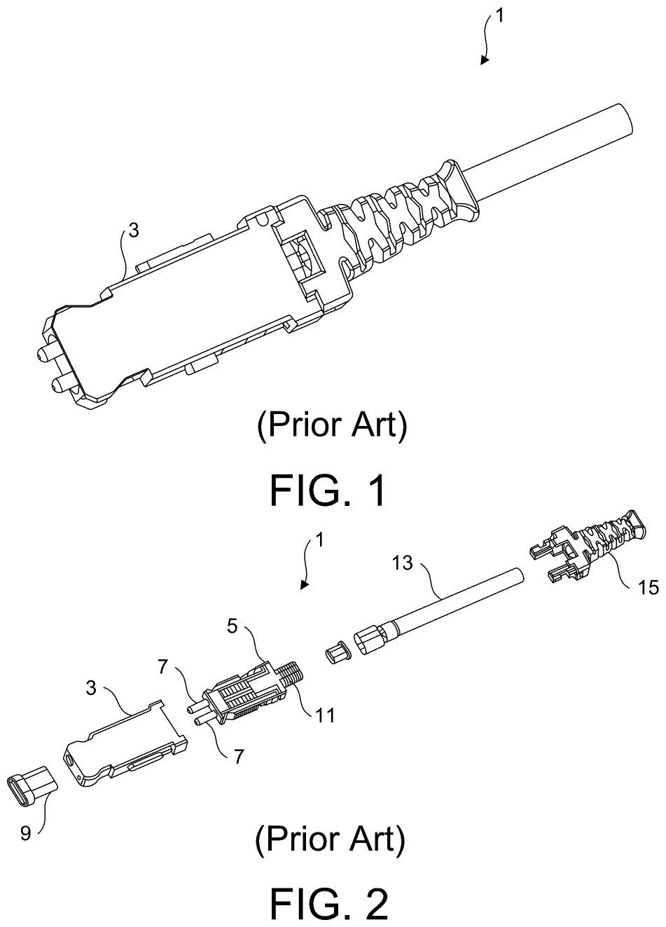

Corresponding parts are given corresponding reference characters throughout the drawings.

### DETAILED DESCRIPTION

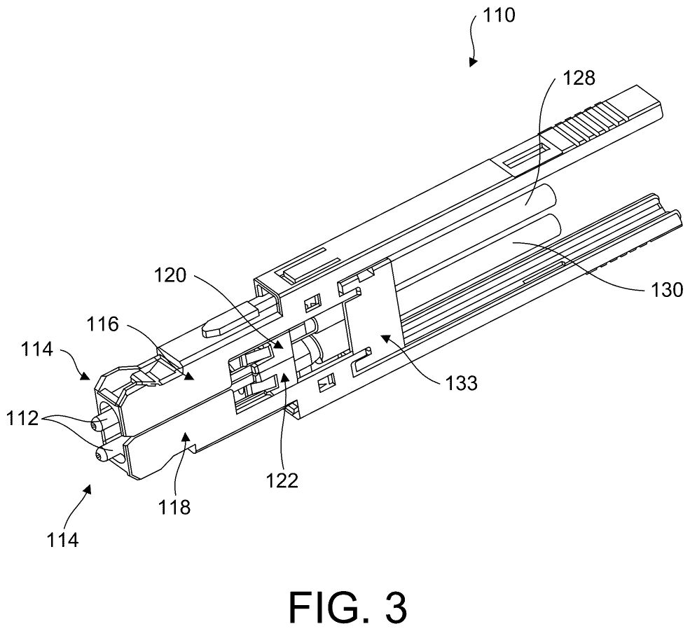

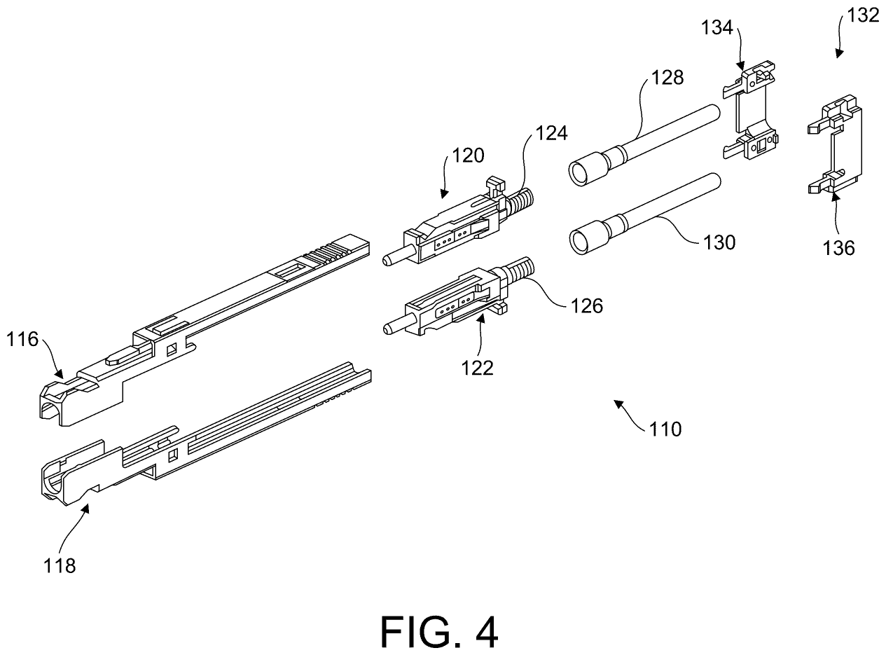

Referring to FIGS. 3 and 4, an exemplary embodiment of a duplex optical fiber connector in the scope of this disclosure is generally indicated at reference number 110. As will be explained more fully below, connectors in the scope of this disclosure can comprise one or more optical fiber ferrules held in one or more housing components. In the illustrated embodiment, the connector 110 holds single-fiber ferrules 112 (e.g., LC ferrules, cylindrical ferrules, round ferrules). As will be described more fully hereinafter, the duplex fiber optic connector 110 is made up of two simplex fiber optic connectors 114 that can be joined together to form the duplex fiber optic connector. The simplex fiber optic connectors 114 are each capable of being used independently as a simplex fiber optic connector.

The duplex fiber optic connector 110 includes a first housing member 116 and a second housing member 118. There are two (first and second) plug frames, designated generally by reference numerals 120 and 122, respectively. The first and second plug frames 120, 122 each have a corresponding first and second post 124, 126. First and second cables 128, 130 are connected to the respective first and second posts 124, 126 in any suitable manner, such as those well known to those of ordinary skill in the art. Other ways of connecting the first and second cables 128, 130 to the first and second plug frames 120, 122 may be used, including methods that do not require the first and second posts 126, 128. Each of the first and second cables 128, 130 carries a single optical fiber. The first and second housing members 116, 118 can be connected together, along with the first and second plug frames 120, 122 and first and second cables 128, 130 to form the duplex fiber optic connector 110. A clip 132 comprising first and second clip members 134, 136 can be used to join the first and second housing members 116, 118 together, as will be described hereinafter.

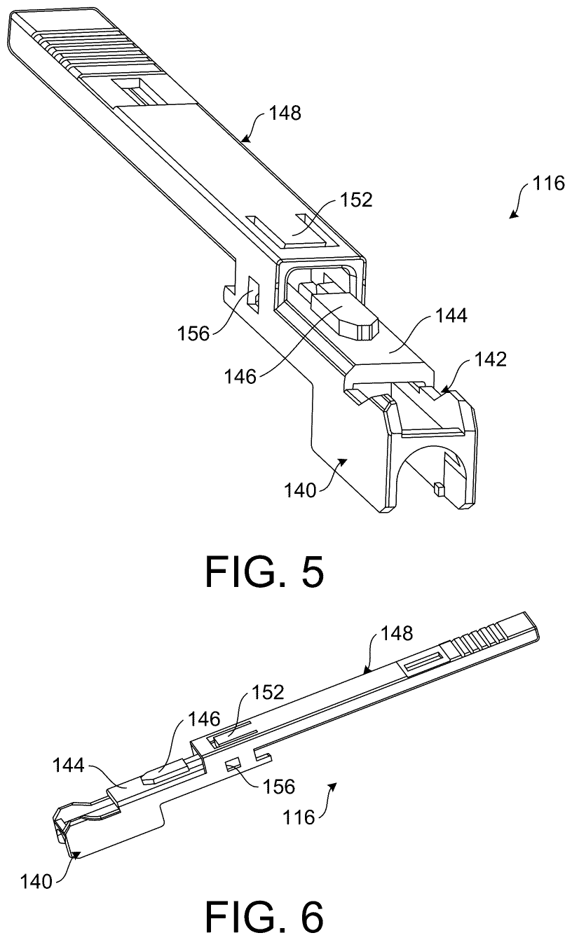

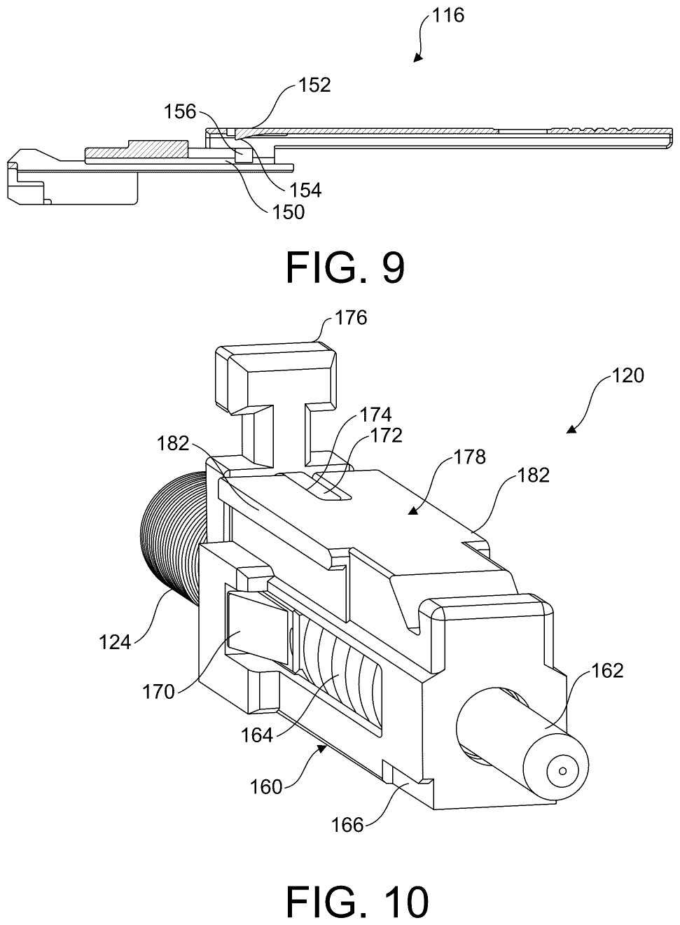

Referring now to FIGS. 5-9, the first housing member 116 is shown in greater detail. The second housing member 118 is of substantially the same construction as the first housing member 116. Accordingly, a description of the first housing member 116 also suffices for the second housing member 118, which will not be separately described in detail. The first housing member 116 includes two side walls and has a generally inverted channel shape including an open bottom. The first housing member 116 includes front portion 140 and a rear portion 148. The first plug frame 120 is mostly received in the channel of the front portion 140. The front portion is formed with connection structure 142 on its top side at the forward end of the top side. However, it is envisioned that other types of connection structure could be used. A top wall 144 is spaced rearward of the front end of the front portion 140 and of the connection structure 142. The top wall 144 closes part of the top side of the front portion 140. The top wall 144 includes a polarity key 146 that can be provided to allow the duplex fiber optic connector 110 to be inserted in only one orientation into an adapter or other connection receptacle. An elongate rear portion 148 is integrally joined with the front portion 140 and extends rearward from the front portion. The rear portion 148 can be used for grasping a specific (simplex or duplex) fiber optic connector when plugged together in close proximity with other fiber optic connectors, and releasing connection of the fiber optic connector to a receptacle (not shown).

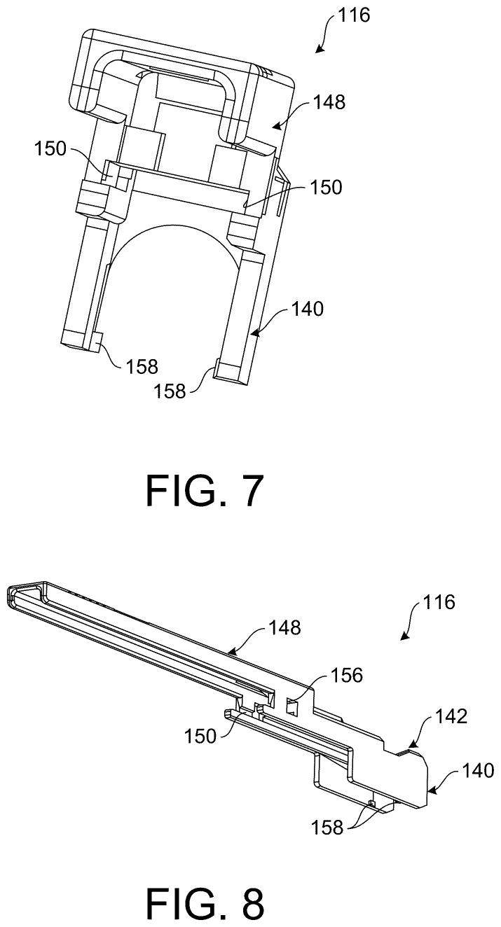

The first housing member 116 is formed to attach and hold the first plug frame 120 independently of being connected to the second housing member 118. In that regard, interior side walls of the front portion 140 of the first housing member 116 are formed with grooves 150 (FIGS. 7-9) that open to the rear of the front portion and extend forward from the open rear ends along the length of the front portion 140. As described more fully hereinafter, these grooves 150 receive parts of the first plug frame 120 to connect the first plug frame to the first housing member 116. As may be seen in FIGS. 5, 6 and 9, the rear portion 148 has a cutout forming a resilient latch arm 152. The underside of the latch arm 152 is formed with a ramp surface 154 for use in activating the latch arm to snap the first plug frame 116 into connection with the first housing member 116. Side walls of the rear portion 148 each have openings 156 that are used for facilitating the coupling of the first housing member 116 to the second housing member 118, as will be described hereinafter. The front portion 140 includes protrusions 158 at the lower ends of its side walls configured to cooperate with the grooves 150 for holding the first plug frame 120 in the first housing member 116.

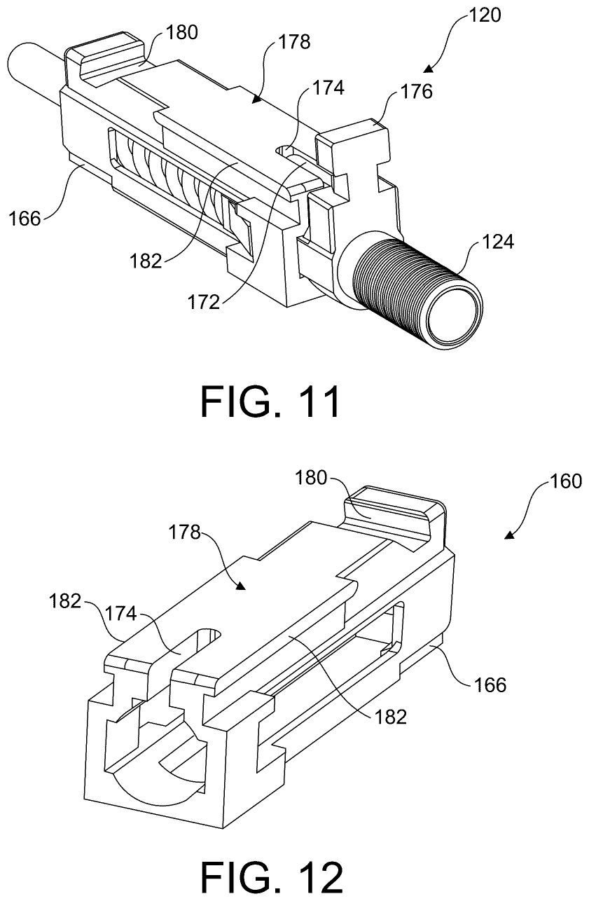

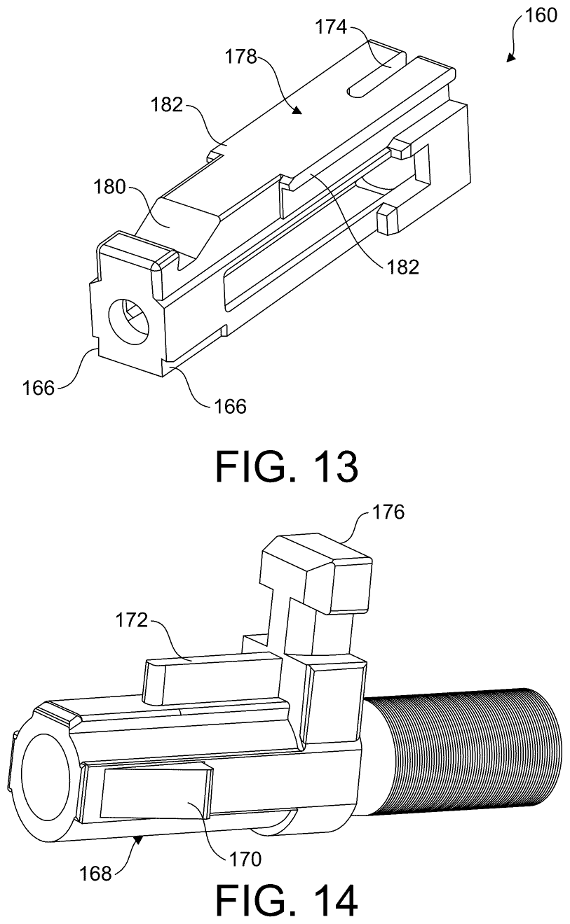

FIGS. 10-14 show the first plug frame 116 and parts thereof by themselves. The second plug frame 118 has a construction substantially identical to the first plug frame 116. Accordingly, only a description of the first plug frame 116 will be made in detail. The first plug frame 116 includes a body 160 and a ferrule 162 received in the body. The body 160 is shown by itself in FIGS. 12 and 13. The ferrule 162 is a single fiber ferrule and receives and terminates the optical fiber of the first cable 128. It will be understood that other types of ferrules (not shown) and numbers of fibers terminated by those ferrules may be used. A forward, lower end of the body 160 is formed with a notch 166 on each side of the body. The notches 166 receive respective ones of the protrusions 158 of the first housing member 116 when the first plug frame 120 is attached to the first housing member 116. The ferrule 162 is biased by a spring 164 held in the body 160 by an inner body 168 (FIG. 14). As illustrated, the inner body 168 is connected to the first post 124. This allows the ferrule 162 to move with respect to the body 160 when making an optical connection. The inner body 168 includes a pair of wedges 170 that, when the inner body is pushed into the body 160 snap through elongated side openings in the body 160 to fix the inner body 168 in the body. An upper surface of the inner body 168 has a spine 172 that is received in a slot 174 in the top wall 144 of the body 160. The slot 174 and spine 172 determine the specific orientation of the inner body 168 in the body 160.

The inner body 168 further includes a stop 176 that has a generally “T” shape. The stop 176 is on the same side of the inner body 168 as the spine 172, which provides some mechanical reinforcement for the stop. The undercut sides of the T-shaped stop 176 allow the top of the stop to ride over rear end portions of the top wall 144 of the front portion 140 of the first housing member 116 to further interconnect the first plug frame 120 and the first housing member 116. The top of the stop 176 also engages the latch arm 152 of the first housing member 116. More specifically, the latch arm 152 snaps into place behind the stop 176 and rests against the stop when the first plug frame 120 is assembled with the first housing member 116. This prevents the first plug frame 120 from moving reward out of connection with the first housing member 116.

The body 160 further includes an upper wall 178. The slot 174 is located in the upper wall 178 at its rear end. A latching channel 180 is formed in the upper wall 178 near the front end to receive a latch (not shown) to assist in connecting the duplex fiber optic connector 110 or the simplex fiber optic connector 114 to an adapter or other receptacle. The body 160 is formed so that a rearward section of the upper wall 178 overhangs the sides of the body, forming wings 182 on either side of the body. The wings 182 are located so that they can slide into the grooves 150 formed on the interior of the side walls of the front portion 140 of the first housing member 116.

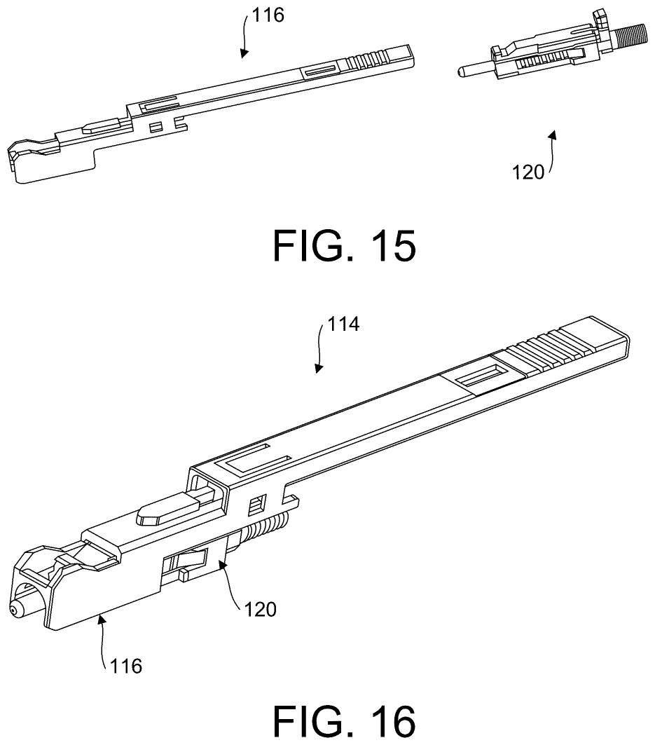

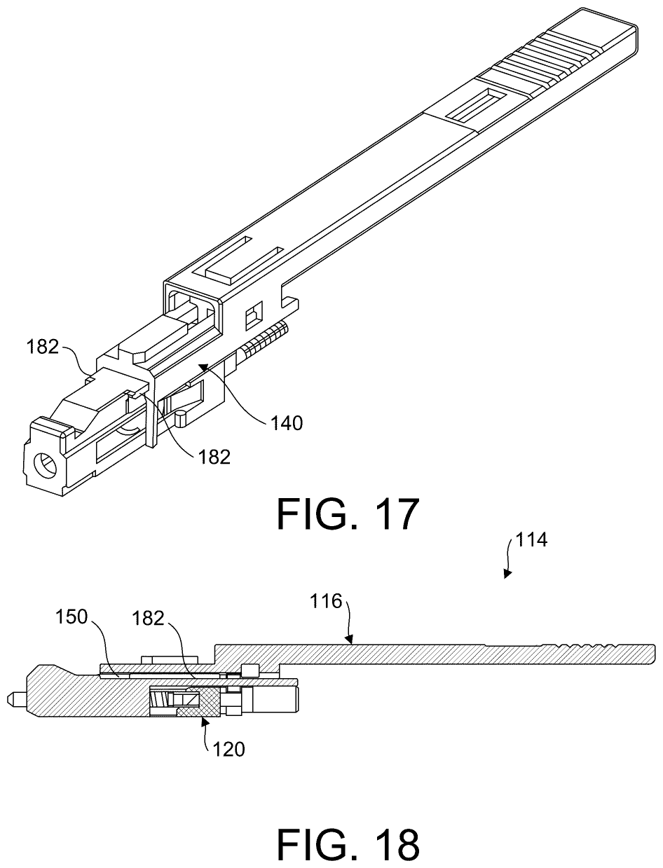

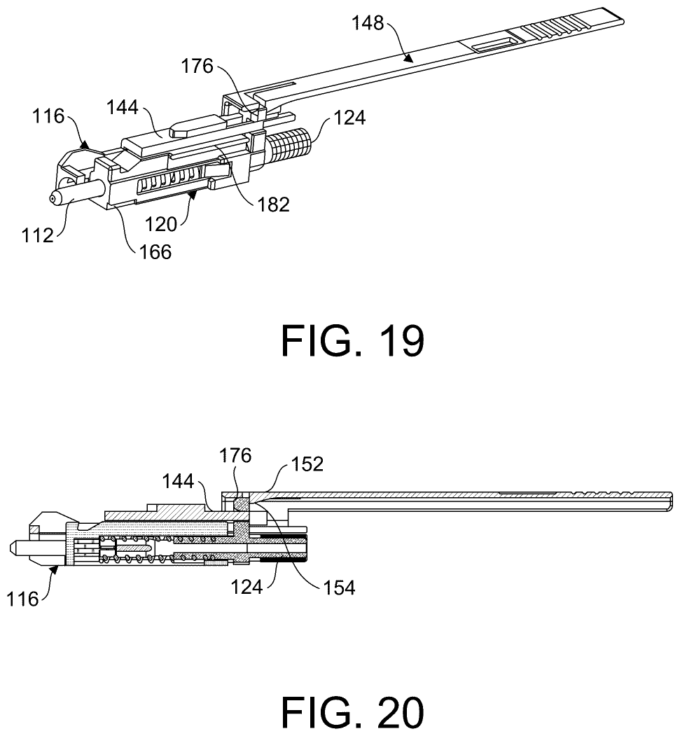

Referring now to FIGS. 15-20, the assembly of the first plug frame 120 with the first housing member 116 will be described. Assembly of the second plug frame 122 with the second housing member 118 would be carried out the same way and will not be separately described. The first plug frame 120 is axially aligned with the first housing member 116 at a position rearward of the first housing member. The first housing member 116 and first plug frame 120 are moved with respect to each other so that the first plug frame moves into the channel of the front portion 140 of the first housing member 116. As this movement continues, the wings 182 of the body 160 are received in the grooves 150 on the interior of the side walls of the front portion 140 begin to connect the first plug frame 120 with the first housing member 116. Further movement of the first plug frame 120 causes the protrusions 158 to be received in the notches 166 on the front of the body 160. In addition, also near the end of the relative movement, the stop 176 rides up onto the rear end portion of the top wall 144 of the front portion 140. The interaction of the wings 182 with the grooves 150, the protrusions 158 with the notches 166 and the stop 176 with the rear end of the top wall 144 holds the first housing member 116 and the first plug frame 120 together so that they cannot be pulled apart by movement perpendicular to the insertion direction of the plug frame into the first housing member. Moreover, as the stop 176 is moving onto the top wall 144, the top of the stop engages the ramp surface 154 of the latch arm 152. The stop 176 pushes the latch arm 152 upward until the stop moves completely past the latch arm. Once the stop 176 moves beyond the front end of the latch arm 152, the resiliency of the latch arm causes it to return and snap down behind the stop. In its position behind the stop 176, the latch arm 152 prevents the first plug frame 120 from moving rearward out of the first housing member 116. The front end of the first housing member 116 is constructed to engage and prevent further relative forward movement of the first plug frame 120 with respect to the first housing member 116. As a result, the first plug frame 120 is entirely captured in the first housing member 116. This allows the assembled first housing member 116 and first plug frame 120 to act as a simplex fiber optic connector 114.

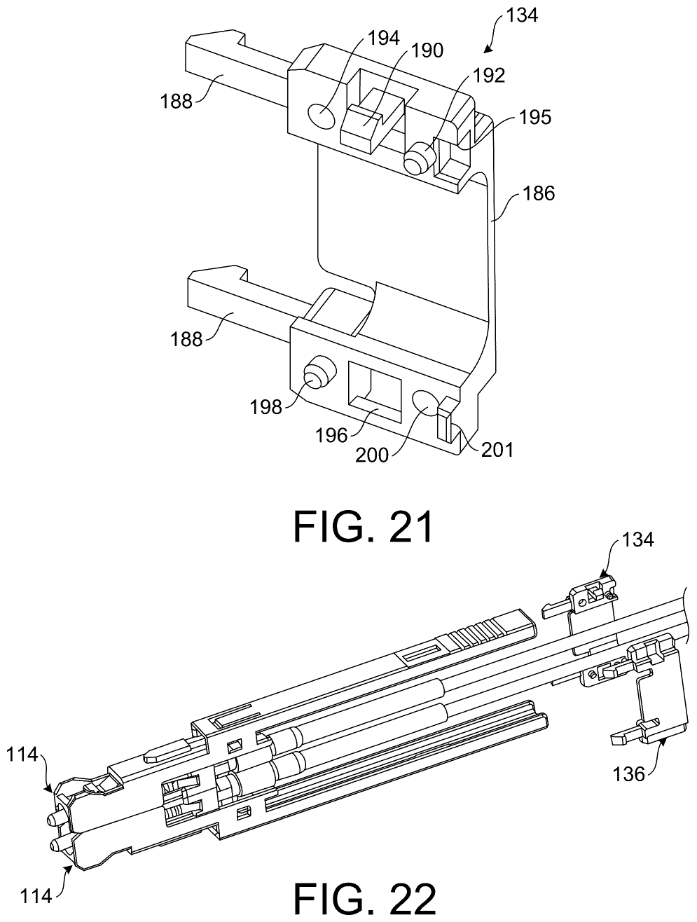

The assembly of the first housing member 116 and the second housing member 118 (each individually usable as a simplex fiber optic connector 114) is describe with reference to FIGS. 21-25. As a first step, the first housing member 116 and the second housing member 118, carrying the first plug frame 120 and the second plug frame 122 are stacked one on top of the other, as shown in FIG. 22. The second housing member 118 and second plug frame 122 are inverted from the orientation of the first housing member 116 and the first plug frame 124 in the stack. As a result, the first plug frame member 120 and the second plug frame member 122 are sandwiched between the first housing member 116 and the second housing member 118. As may be seen, the first and second cables 128, 130 extend rearward from the first and second housing members 116, 118 and first and second plug frames 120, 122.

In order to attach the simplex connectors 114 together to form the duplex connector 110, the clip members 134, 136 can be arranged on opposite sides of the first and second cables 128, 130 as shown in FIG. 22. Each clip member 134, 136 may have the same construction, and the first clip member 134 is shown in FIG. 21. The first clip member 134 includes a channel-shaped body 186 and hooks 188 extending from respective first and second side portions of the body. The first side portion of the body 186 is formed with a catch 190, a nub 192 rearward of the catch and a hole 194 forward of the catch. A recess 195 is disposed at a rear end of the first side portion. The second side portion of the body 186 is formed with an opening 196, a nub 198 forward of the opening and a hole 200 rearward of the opening. A short finger 201 is disposed at a rear end of the second side portion.

The second clip member 136 has the same construction as the first clip member 134, but in use is flipped over to oppose the first clip member. Thus the location of the first and second side portions of the body of the second clip member 136 are reversed from the first and second side portions of the first clip member 134. Therefore, the catch 190 on the first portion of the body 186 of the first clip member 134 is positioned opposite the opening 196 of the second portion of the second clip member 136. Similarly, the nub 192 on the first portion of the body 186 of the first clip member 134 opposes the hole 200 on the second portion of the second clip member 136, and the hole 194 on the first portion of the body of the first clip member opposes the nub 198 on the second portion of the second clip member 136. The recess 195 on the first portion of the first clip member 134 is opposite the short finger 201 of the second portion of the second clip member 136. The short finger 201 on the second portion of the first clip member 134 is directly across from the recess 195 on the first portion of the second clip member 136. A corresponding, mateable arrangement of components exists for the features of the second side portion of the first portion of the body 186 of the first clip member 134 and those of the first side portion of the second clip member 136.

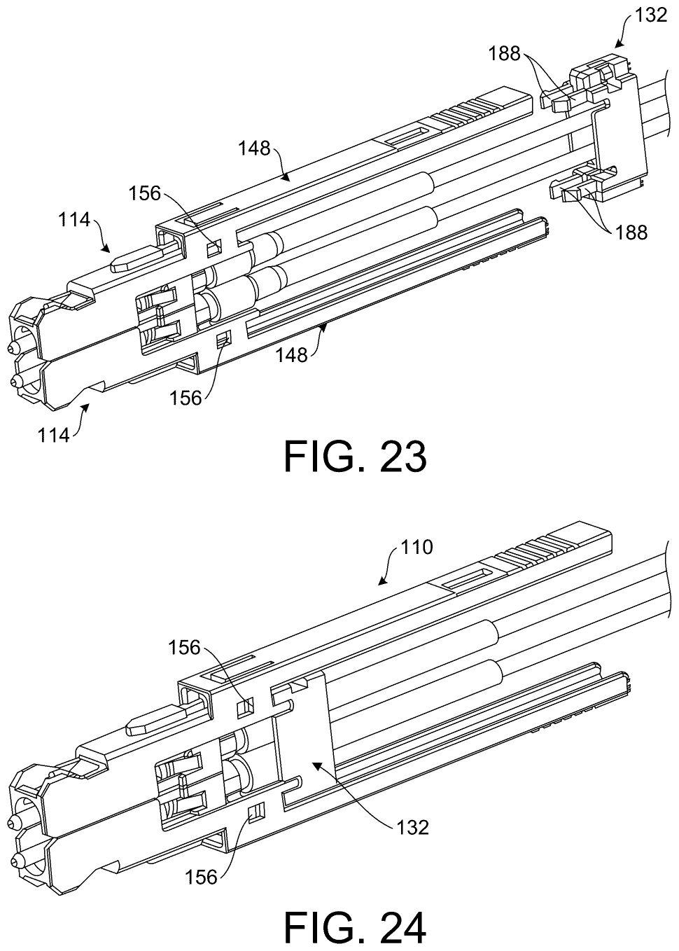

The first and second clip members 134, 136 can be pushed together so that the first and second cables 128, 130 are received in the bodies 186 of the first and second clip members. The catches 190 of the first and second clip members 134, 136 are received in corresponding openings 196 and lock the first and second clip members together around the first and second cables 128, 130. The nubs 192, 198 are received in corresponding holes 194, 200, and the short fingers 201 are received in the recesses 195. This configuration is shown in FIG. 23.

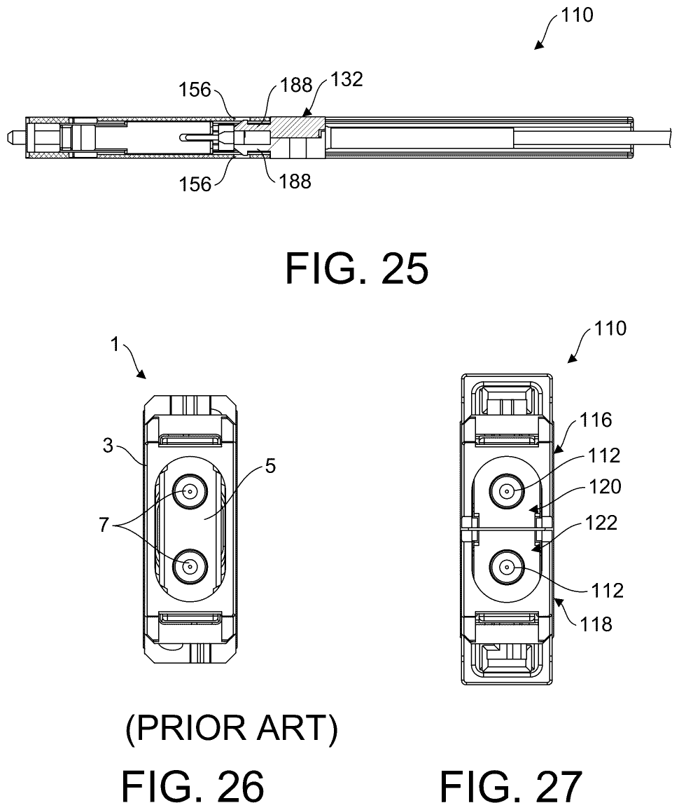

The assembled clip 132 can be pushed forward passing along the first and second cables 128, 130 between the rear portions 148 of the first and second housing members 116, 118. Upon approaching the forward ends of the rear portions 148, the forward, ramp surfaces of the hooks 188 engage side walls of the rear portions, and are deflected inwardly toward each other under the force applied by the side walls. Continued movement of the clip 132 toward the front portion 140 brings the ends of the hooks 188 into registration with the openings 156 in the side walls of the rear portions 148. The resilient hooks 188 snap outward and into the openings 156 (see FIG. 25). The clip 132 is now holding together the two simplex connectors 114, thereby forming the duplex connector 110. As shown by comparison of FIG. 27 with FIG. 26, the front end configuration of the duplex fiber optic connector 110 is closely similar to the front end configuration of the prior art duplex connector. In fact, they can be used in the same connections.

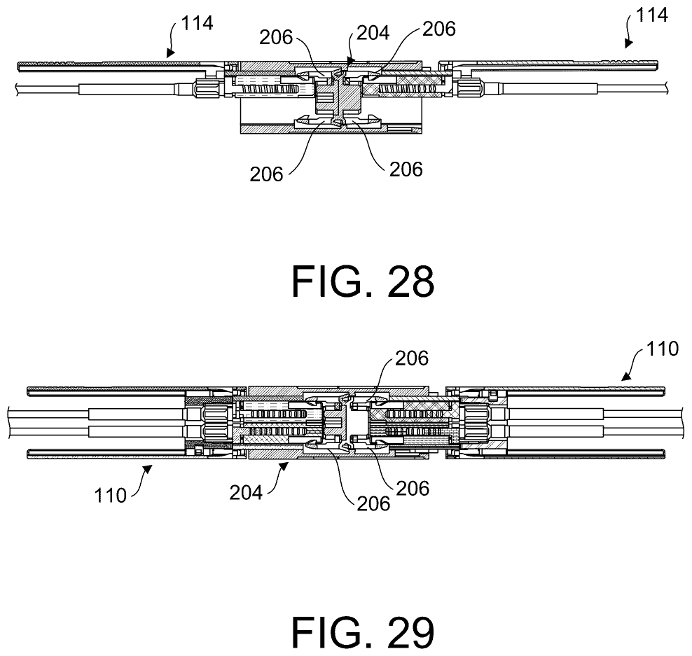

FIG. 28 illustrates two simplex connectors 114 being received in an adapter 204. The adapter 204 includes latching hooks 206 that are capable of connecting the simplex connectors 114 in the adapter. Each hook can be received in the connection structure 142 and latching channel 180 of the simplex connector 114 to secure the connector in the adapter. The simplex connectors 114 can be reconfigured as the duplex connector 110 (as described above) and attached to the same adapter 204. In this instance the latching hooks 206 on both top and bottom of the adapter 204 are employed.

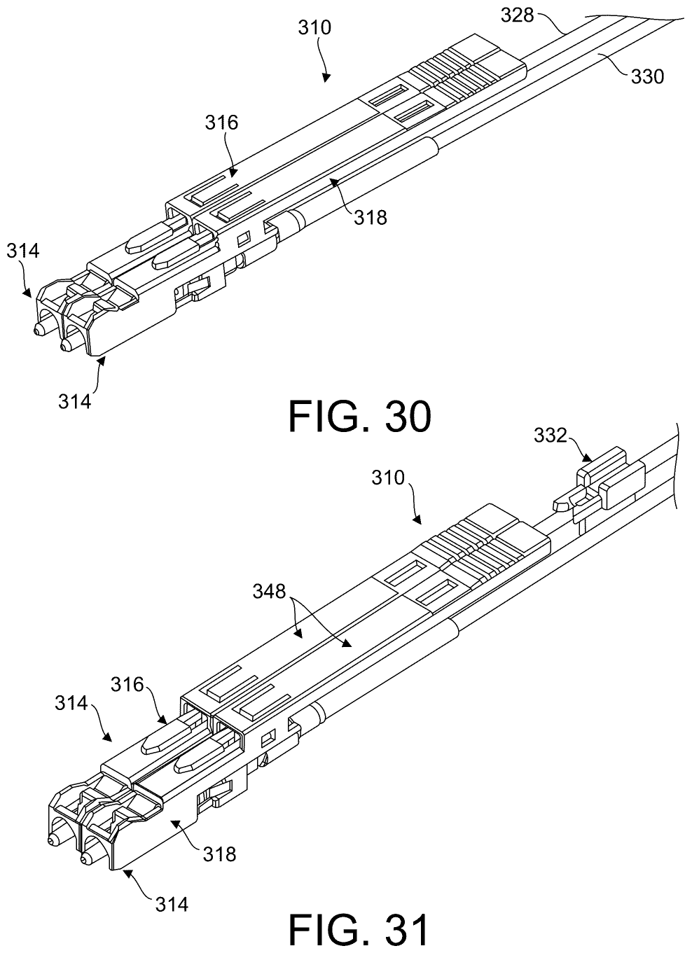

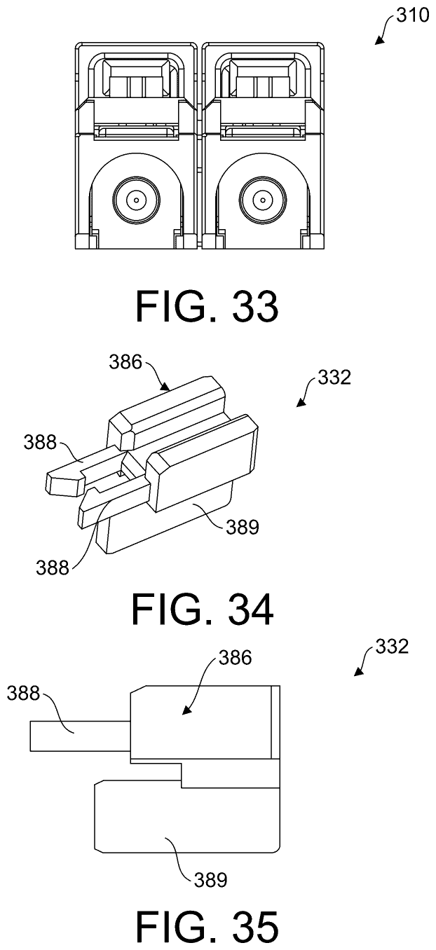

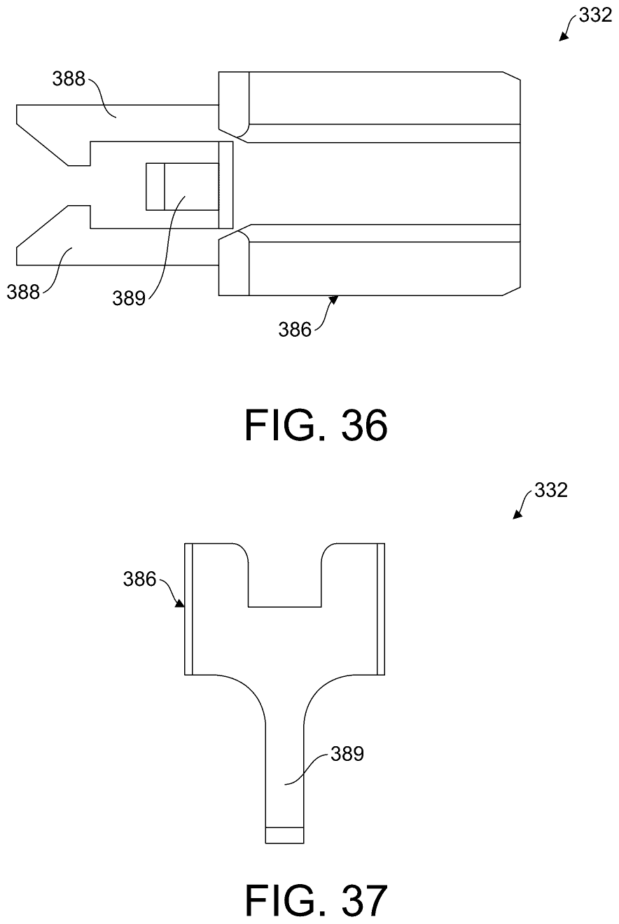

Referring now to FIGS. 30-37, a duplex fiber optic connector 310 of a second embodiment is shown. Corresponding parts of the duplex fiber optic connector 310 will be given the same reference numerals as for the duplex fiber optic connector 110 of the first embodiment, plus “200.” As will be understood, these duplex connector 310 is formed by simplex connectors 314 attached side-by-side, rather than stacked one on top of the other as in the duplex connector 110. The clip 332 is formed differently from the clip 132 of the first embodiment and the first and second housing members 316, 318 are formed differently to connect with the clip 332. As shown in FIGS. 34-37, the clip 332 is a unitary piece and includes a channel-shaped body 386 and a pair of hooks 388 projecting forward from the body. In this embodiment, the hooks 388 face inwardly toward each other rather than outwardly, as with the hooks 188 of the clip 132. A panel 389 extends below and forward of the body 386. A portion of the panel 389 underlies the hooks 388.

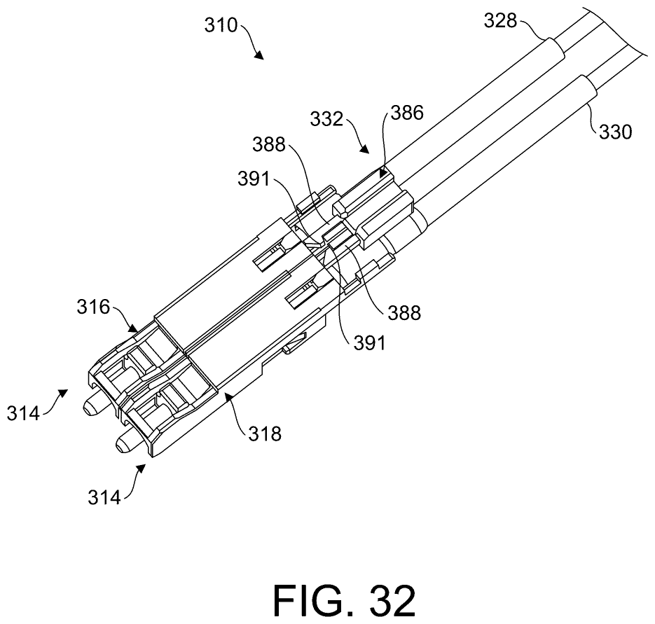

To connect the simplex fiber optic connectors 314 together to form the duplex fiber optic connector 310, the clip 332 is pushed forward relative to the simplex connectors from an initial position shown in FIG. 31 to the position shown in FIG. 32. Abutting side walls of rear portions 348 of the simplex connectors 314 engage each other on the interior at the junction of the first housing member 316 with the second housing member 318. The abutting side walls have aligned openings 391 that receive catch portions of the hooks 388, as shown in FIG. 32. As the clip 332 is pushed forward ramp surfaces of the hooks 388 engage rear edges of the abutting side walls, and are wedged apart. Once the catch portion of the hooks 388 align with the respective openings 391, the hooks snap into the openings to hold the simplex connectors 314 together to form the duplex connector 310. A forward, projecting portion of the panel 389 engages other portions of the first and second housing members 316, 318 and further stabilizes the connection.

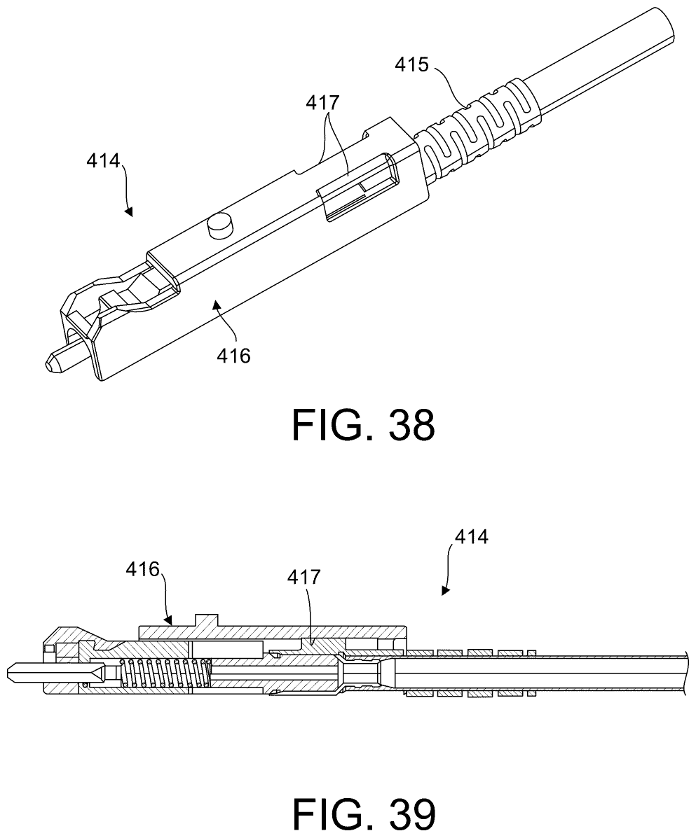

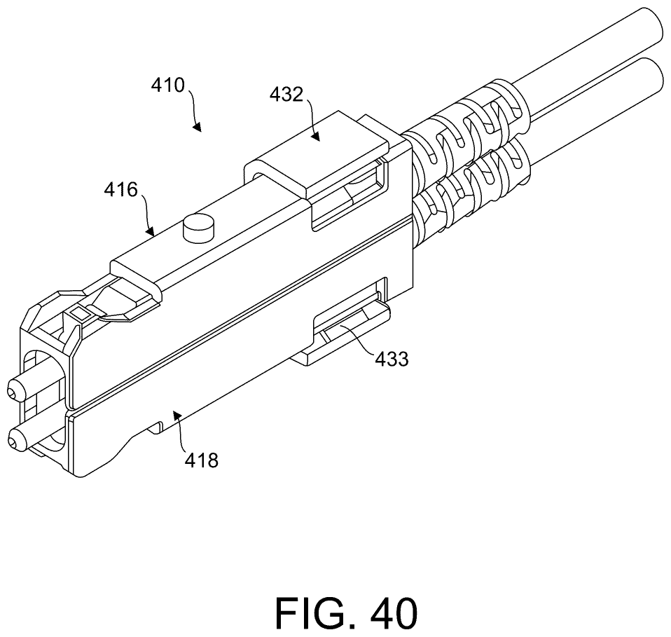

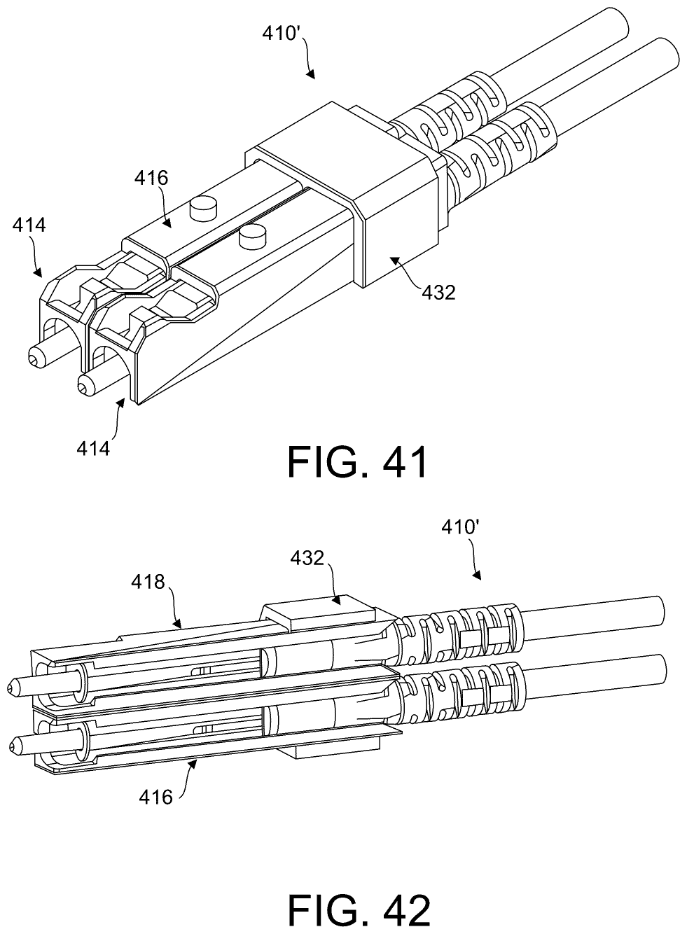

A third embodiment of a simplex connector 414 is shown in FIGS. 38 and 39. The simplex connector 414 is similar in construction to the simplex connector, and so corresponding parts are given the same numbers, plus “300.” The simplex connector 414 can be attached to another simplex connector having the same construction to form a duplex connector. The other simplex connector would be inverted from the position of the simplex connector 414 shown in FIGS. 38 and 39. A first housing member 416 has an open bottom, a top wall and two opposite side walls. Unlike the simplex connector 114 of the first embodiment, rear portion 148 does not extend rearward of the boot 415. The connector 414 is configured so that by pulling on the boot 415, the connector 414 is able to release its connection with the adapter or other receptacle. Near the rear end of the first housing member 416, there are two rectangular openings 417, each partially in a respective side wall and in the top wall. Referring now to FIG. 40, the simplex connector 414 of FIG. 38 can be stacked on top of another simplex connector of the same construction. The other simplex connector is inverted so that the open bottoms of the first and second outer housings 416, 418 adjoin one another in the stack. A C-shaped clip 432 is used to secure the simplex connectors 414 together to form a duplex fiber optic connector 410. At each of the free ends of the clip 432, a catch 433 is positioned to engage the first or second housing member 416, 418 in the opening 417. In this way, the clip 432 secures together to two simplex fiber optic connectors. Referring now to FIGS. 41 and 42, it may be seen that the simplex connectors 414 can be secured together in a side-by-side relation for form a duplex fiber optic connector 410′. As may be seen in FIG. 42, the open bottoms of the first and second housing members 416, 418 both open downward and not adjoining as for the duplex fiber optic connector 410.

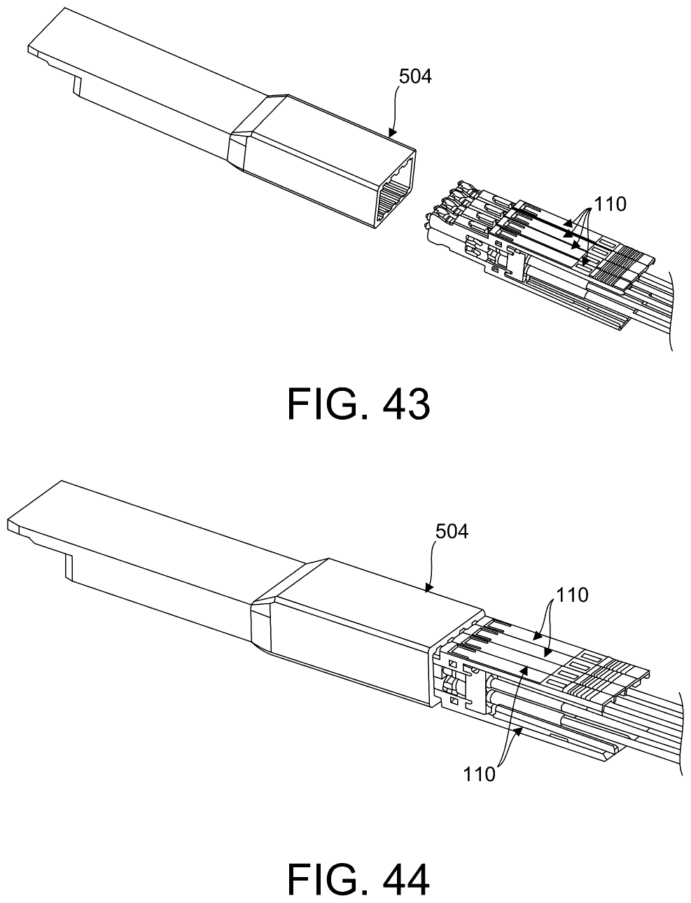

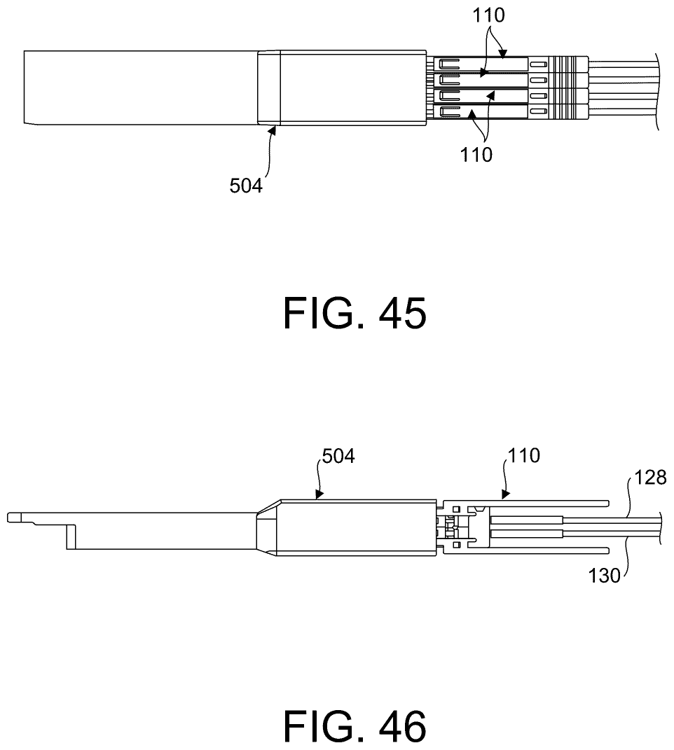

Use of duplex connectors 110 according to the present invention in conjunction with a transceiver 504 is shown in FIGS. 43-46. Four duplex connectors 110 can be put together and connected to a transceiver having a QSFP-DD footprint. This allows for very high density connections to be made.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the disclosure are achieved and other advantageous results attained.

As various changes could be made in the above products and methods without departing from the scope of the disclosure, it is intended that all matter contained in the above description shall be interpreted as illustrative and not in a limiting sense.

What is claimed is:

1. A configurable fiber optic connector comprising:
a first housing member;
a second housing member;
a first plug frame including a body and a ferrule received in the body, the first plug frame being constructed to be held by the first housing member separate from the second housing member;
a second plug frame including a body and a ferrule received in the body, the second plug frame being constructed to be held by the second housing member separate from the first housing member;
the first and second housing members being adapted to be connected to each other for holding the first and second plug frames together as a duplex fiber optic connector.

2. The fiber optic connector as set forth in claim 1 wherein the first plug frame includes a post constructed to mount a first fiber optic cable to the first plug frame, and the second plug frame includes a post constructed to mount a second fiber optic cable to the second plug frame.

3. The fiber optic connector as set forth in claim 1 wherein the first plug frame member is constructed for snap in connection with the first housing member and the second plug frame member is constructed for snap in connection with the second housing member.

4. The fiber optic connector as set forth in claim 3 wherein at least one of the first plug frame and the first housing member includes a resilient latch positioned to engage the other of the first housing member and first plug frame for holding the first plug frame in the first housing member, and at least one of the second plug frame and the second housing member includes a resilient latch positioned to engage the other of the second housing member and second plug frame for holding the second plug frame in the second housing member.

5. The fiber optic connector as set forth in claim 4 wherein the first housing member includes the resilient latch and the second housing member includes the resilient latch.

6. The fiber optic connector as set forth in claim 5 wherein the first plug frame includes a stop engageable with the resilient latch of the first housing member for holding the first plug frame in the first housing member, and the second plug frame includes a stop engageable with the resilient latch of the second housing member for holding the second plug frame in the second housing member.

7. The fiber optic connector as set forth in claim 6 wherein the stops of the first and second plug frames are configured to engage with the first and second housing members, respectively, for holding the first and second plug frames in the first and second housing members.

8. The fiber optic connector as set forth in claim 1 wherein the first housing member and first plug frame are constructed for sliding connection and the second housing member and the second plug frame are constructed for sliding connection.

9. The fiber optic connector as set forth in claim 8 wherein the first housing member is formed with grooves and the first plug frame is formed with wings, each wing of the first plug frame being receivable in a corresponding one of the grooves of the first housing member, and the second housing member is formed with grooves and the first plug frame is formed with wings, each wing of the first plug frame being receivable in a corresponding one of the grooves of the second housing member.

10. The fiber optic connector as set forth in claim 1 further comprising a clip engageable with the first housing member and the second housing member for connecting the first and second housing members together.

11. The fiber optic connector as set forth in claim 10 wherein the first plug frame and the second plug frame are sandwiched between the first housing member and the second housing member when the first and second housing members are connected together by the clip.

12. The fiber optic connector as set forth in claim 10 wherein the first plug frame and the second plug frame are arranged next to each other when the first and second housing members are connected together by the clip and portions of the first and second housing members are disposed between the first plug frame and the second plug frame.

13. The fiber optic connector as set forth in claim 10 wherein the clip has a central passage sized and shaped to receive a first fiber optic cable through the clip and a second fiber optic cable through the clip.

14. The fiber optic connector as set forth in claim 10 wherein the clip comprises a first clip member and a second clip member, the first and second clip members being constructed for snap together connection.

15. The fiber optic connector as set forth in claim 1 in combination with three additional fiber optic connectors having the same construction as the fiber optic connector, the fiber optic connector and three addition fiber optic connectors being sized to simultaneously fit into a receptacle having a QSFP-DD footprint.

16. The fiber optic connector as set forth in claim 1 wherein the first housing member includes a polarity key and the second housing member includes a polarity key.

17. The fiber optic connector as set forth in claim 1 wherein the ferrule of the first plug frame is supported by the body of the first plug frame for movement with respect to the body, and the ferrule of the second plug frame is supported by the body of the second plug frame for movement with respect to the body.

18. The fiber optic connector as set forth in claim 17 wherein the first plug frame further includes a spring biasing the ferrule of the first plug frame in a direction outward from the body of the first plug frame, and the second plug frame further includes a spring biasing the ferrule of the second plug frame in a direction outward from the body of the second plug frame.

19. The fiber optic connector as set forth in claim 1 wherein the first housing member and first plug frame as received in the first housing member are constructed to form a first simplex SN connector, and the second housing member and second plug frame as received in the second housing member are constructed to form a second simplex SN connector.

20. The fiber optic connector as set forth in claim 18 wherein the first plug frame, first housing member, second plug frame and second housing member form a duplex SN connector when the first and second housing members are mated with each other.
